(19) United States
(12) Patent Application Publication
(10) Pub. No.: US 2013/0055482 A1
(43) Pub. Date: Mar. 7, 2013

(54) METHOD FOR DESIGNING A PROTECTIVE GLOVE TO BE USED IN PERFORMING A CYCLE OF MANUAL OPERATIONS IN AN INDUSTRIAL PRODUCTION LINE, AND GLOVE DESIGNED BY THIS METHOD

(71) Applicants: Paola D'Aprile, Orbassano (Torino) (IT); Sebastiano Lamacchia, Orbassano (Torino) (IT); Davide Lionello, Orbassano (Torino) (IT); Stefania Spada, Torino (IT); Paolo Marchetti, Torino (IT)

(72) Inventors: Paola D'Aprile, Orbassano (Torino) (IT); Sebastiano Lamacchia, Orbassano (Torino) (IT); Davide Lionello, Orbassano (Torino) (IT); Stefania Spada, Torino (IT); Paolo Marchetti, Torino (IT)

(73) Assignee: FIAT GROUP AUTOMOBILES S.p.A., Torino (IT)

(21) Appl. No.: 13/598,056

(22) Filed: Aug. 29, 2012

(30) Foreign Application Priority Data
Sep. 2, 2011 (EP) 11179830.2

(51) Int. Cl. A41D 13/08; B23P 17/04

(52) U.S. Cl. 2/20; 29/592

(57) ABSTRACT

There is described a method for designing and manufacturing a protective glove, to be used for imparting slight knocks in performing a cycle of manual operations in an industrial production line and for absorbing the counter-knock received when using a tool or equipment gripped by the operator during said operating cycle. There are provided means for sensing the forces the various areas of the hand are subjected to during said operating cycle, and signals of said sensor means are processed so as to obtain a classification of the areas of the hand according to the value of the forces to which they are subjected. The glove is designed having areas that provide differentiated protections, having pads of different thickness calculated as a function of the aforementioned classification of the various areas of the hand.

### FIELD OF THE INVENTION

The present invention refers to a method for designing and manufacturing a protective glove to be used in performing a cycle of manual operations in an industrial production line, and a glove designed by this method.

Over the last years there has been an ever-growing need for guaranteeing that the manual operations performed by an operator during the work thereof are ergonomically acceptable and that they are not harmful for the operator in question.

A possible origin of inconveniences for the operator, and in particular for the hand thereof, arise from the need—during the work cycle—to impart slight knocks using the hand to structures or elements to be assembled to each other.

A further source of unwanted stresses derives from the use of tools that the operator grips with the hand, such as for example a hammer or a screw runner or a nail gun or welding clamp. When using such equipment, the wrist of the hand that grips the equipment is subjected to a counter-knock. For example, in the case of the hammer, such counter-knock is due to the rebound of the hammer on the knocked part. In the case of a screw runner, the counter-knock is due to the reaction on the hand after reaching the maximum fastening torque. Up to date, the presence or absence of a counter-knock on the wrist of the operator was simply evaluated through observation by sight, without any possibility of measuring it in terms of force or generated torque.

### OBJECT OF THE INVENTION

The object of the invention is to provide a protective glove capable of guaranteeing a suitable protection to the operator during the work cycle thereof, in particular with reference to the need of imparting slight knocks to the structure to be assembled, but which is simultaneously not a hindrance when performing the operations the operator is intended to perform.

Another object of the present invention is to provide a method capable of allowing measuring the counter-knock received by the wrist of an operator when using a tool gripped by the operator, according to a method capable of guaranteeing the reliability of the detection.

### SUMMARY OF THE INVENTION

With the aim of attaining such objects, the invention aims at providing a method for designing and manufacturing of a protective glove, to be used for imparting slight knocks in performing a cycle of manual operations in an industrial production line and for absorbing the counter-knock received when using a tool or equipment gripped by the operator during said operating cycle, said method being characterised in that there are provided means for sensing the forces the various areas of the hand are subjected to during said operating cycle, and signals of said sensor means are processed so as to obtain a classification of the areas of the hand according to the value of the forces to which they are subjected, and in that said glove is designed having areas that provide differentiated protections, having pads of different thickness calculated as a function of the aforementioned classification of the various areas of the hand.

As observable, the present invention arises from the discovery of a concept that is apparently simple, but actually not obvious, i.e. the fact that it is erroneous to seek protecting the hand in an undifferentiated manner in every area thereof using a pad with the highest amount of thickness possible. Such solution does not overcome the problem, in that it creates a substantial hindrance for the operator when using the hand thereof. Furthermore, an uncomfortable glove may introduce a further safety problem, in that the operator may opt not to use it.

According to a further characteristic of the method according to the invention, said sensor means comprise a plurality of force sensors provided in an auxiliary glove, serving as a measurement instrument, which is used for designing the glove with differentiated protection. The sensors are provided on various phalanges of each finger of the hand of the auxiliary glove and at two lateral areas at the base of the palm and the opposite area of the palm, adjacent to the fingers.

According to a further preferred characteristic of the method of the invention, the sensors are also used for measuring the counter-knock received by the wrist of the operator when using a tool gripped by the operator. For such purpose, the sensors are connected to processing means programmed for monitoring, during the use of the tool, the variation of the force imparted by the tool to the hand of the operator and for particularly determining:
a base value of said force, corresponding to when the hand of the operator grips the tool before performing an operation using the tool,
a peak value achieved by said force during the use of the tool,
said processing means being programmed for calculating the difference between said peak value and said base value of said force and for sending—to display means—an indirect measurement of the counter-knock to which the wrist of the operator is subjected, according to the aforementioned difference of force values imparted to the hand.

Thus, as observable, in the method of the invention there is adopted a specific parameter for indirectly identifying the counter-knock on the wrist of the operator. Such parameter is constituted by the measurement of the force imparted to the hand (not to the wrist) of the operator, without the base value that is generated by simply gripping the tool.

Thus, it is possible to obtain a reliable evaluation of the degree of the counter-knock and outline the operations intended for the operator so as to ensure that under any condition during the work cycle the counter-knock the wrist of the operator is subjected to during the use of the tool is always below a predefined maximum admissible value.

Furthermore, in the glove designed through the method of the invention, preferably the areas with differentiated protection include:
areas of maximum protection, with maximum thickness pad,
areas of intermediate protection, with intermediate thickness pad,
areas of minimum protection, with minimum thickness pad, and
areas without pad.

### BRIEF DESCRIPTION OF THE DRAWINGS

Further characteristics and advantages of the invention will be apparent from the description that follows with reference to the attached drawings, provided purely by way of non-limiting example, wherein:

FIG. 1 illustrates an operator during the performance of an operation,

FIG. 2 shows an embodiment of the sensor means that are used for detecting the force imparted on the hand of the operator,

FIG. 3 illustrates a display example that can be obtained with the apparatus according to the invention,

FIG. 4 is a block diagram of the apparatus used in the method of the invention,

FIG. 5 illustrates a three-dimensional diagram, that can be obtained by means for processing the signals emitted by the sensor means of FIG. 2, which shows the values of the forces to which the various areas of the hand are subjected during the performance of a cycle of manual operations, and

FIGS. 6, 7 show a map of the differentiated protection in the glove according to the invention, respectively on the palm and on the back of the hand.

### DETAILED DESCRIPTION OF THE INVENTION

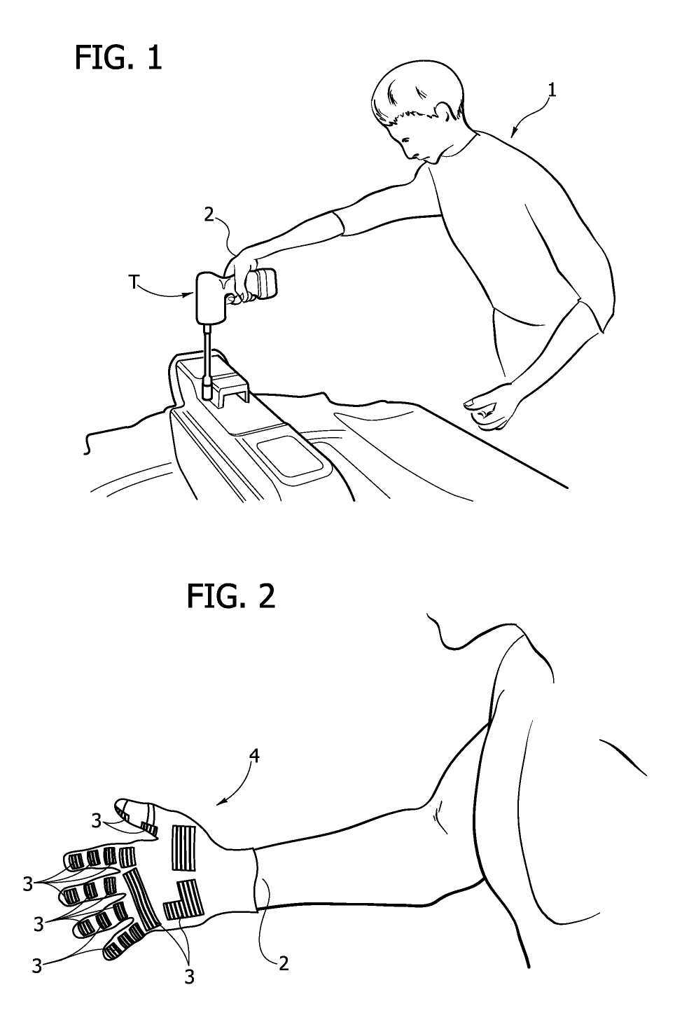

FIG. 1 shows an operator 1 performing a cycle of manual operations in an industrial line. In the figure the operator is shown gripping a screw runner tool T, but during the operations he is intended to perform the operator may need to impart slight knocks for example using the lower part of the palm of the hand, or using the back of the hand or the fist.

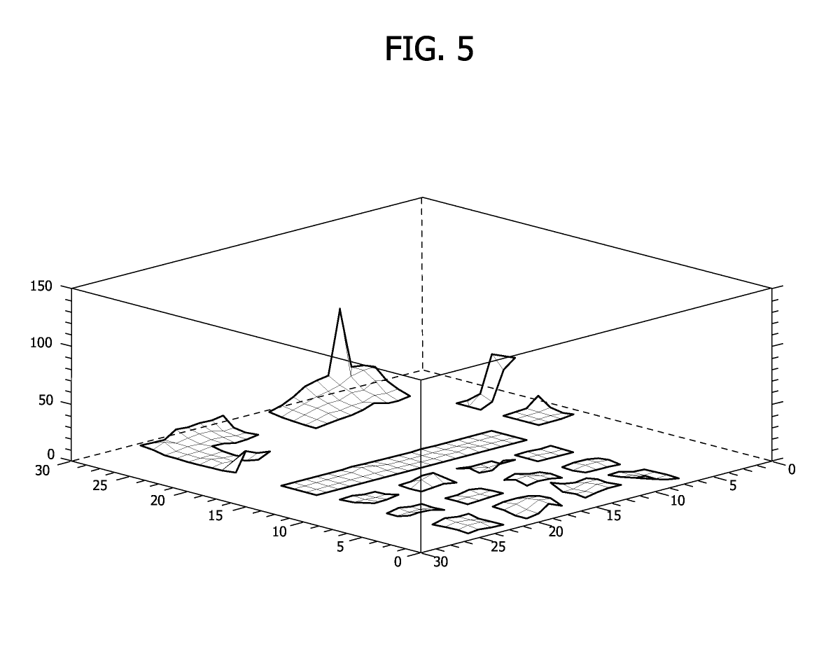

With the aim of designing a glove capable of guaranteeing the required protection of the hand of the operator without jeopardizing comfort and the movement ability thereof, the method according to the invention provides for performing a statistic control of the forces the various areas of the hand of the operator are subjected to during the performance of the operating cycle. Fur such purpose there are provided sensor means 3 which in the case of the illustrated example are constituted by piezoelectric sensors incorporated in an auxiliary glove 4, which is used as a measurement instrument in the method of the invention. Depending on the signals emitted by the sensors 3 while the operator imparts the knocks to a structure to be assembled it is possible to construct diagrams of the type illustrated in FIG. 5, which show the degree of the forces the various areas of the hand are subjected to.

According to such analysis, the method of the invention provides for classifying the various areas of the hand according to the forces to which they are subjected. Correspondingly, the glove according to the invention is provided having areas of different thickness that provide differentiated degrees of protection with respect to each other, with maximum thickness pads, intermediate thickness pads, minimum thickness pads and lastly areas where there is solely provided the lining of the glove, without pad.

In the case of a practical embodiment, in which the glove is made of fabric with pads made of foamed plastic material, the areas with maximum protection, the areas with intermediate protection and the areas with minimum protection have thicknesses that are approximately provided at the 4.5:3:2 ratio with respect to each other. For example the respective thicknesses can measure 4-5 mm, 3 mm and 2 mm

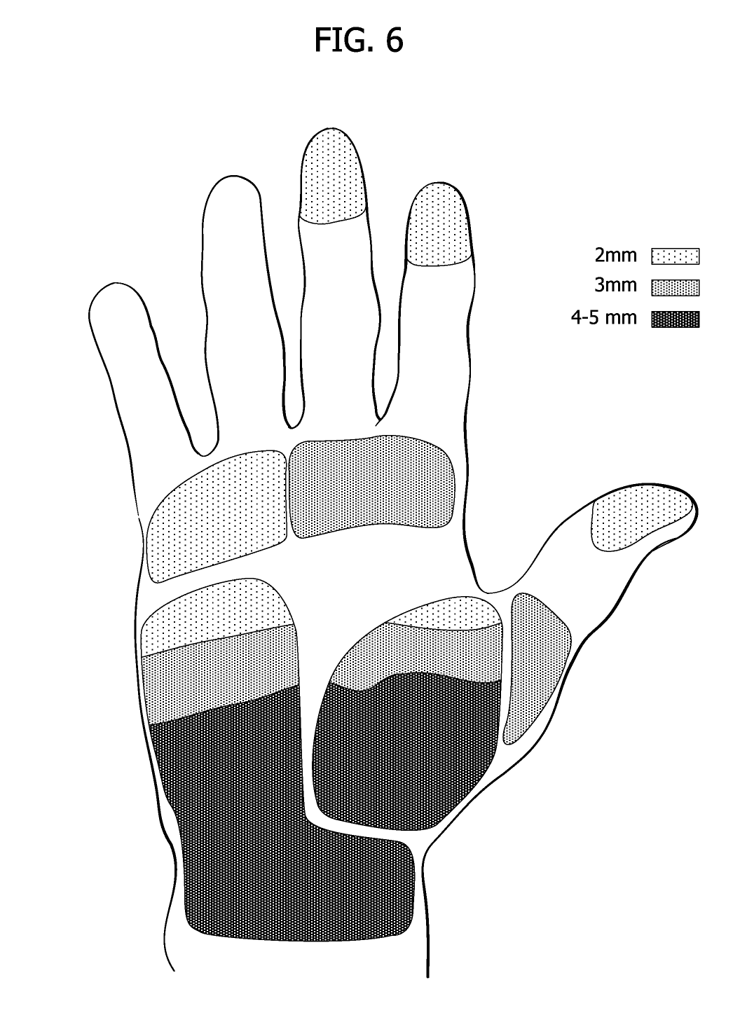

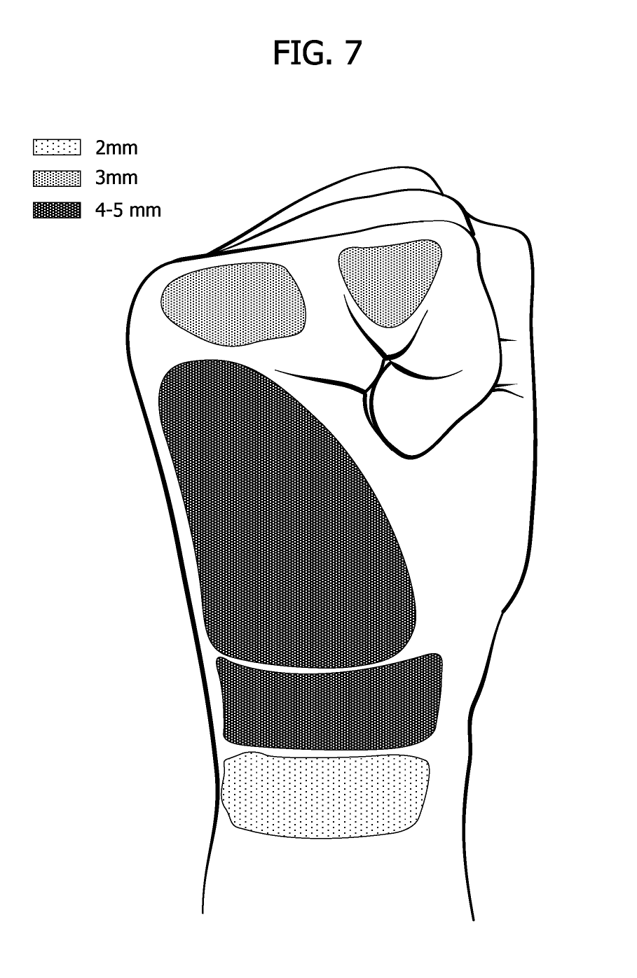

FIGS. 6, 7 show the map of the aforementioned areas in the preferred embodiment of the glove according to the invention.

As observable, the areas of maximum protection are located on the inner face of the wrist and on the proximal portions of the palm of the hand, adjacent to the wrist, as well as on a part of the back, on the side of the little finger; the areas with intermediate protection are located on areas of the palm adjacent to the aforementioned proximal portions of the palm adjacent to the wrist, on a distal portion of the palm adjacent to the base of index finger and middle finger, on the knuckles of the phalanges and on the back of the wrist; the areas with lower protection are located on a distal portion of the palm adjacent to the base of the little finger and ring finger and on the tips of the thumb, index finger and middle finger. The remaining parts of the glove are without pad.

As clear from the description above, the invention provides a protective glove that can be used for performing a cycle of manual operations in an industrial line, for imparting slight knocks using a first or the palm or the back of the hand, having a configuration specifically designed for the task to be performed, with differentiated protections as a function of the degree of forces the various areas of the hand are to be subjected to and having areas of the glove entirely without pad, to allow the glove high characteristics of portability and maneuverability.

According to a further aspect, the method according to the invention also aims at monitoring the counter-knock received by the wrist 2 of the operator 1 during the use of the tool T (the illustrated example refers to the case of a screw runner).

According to the invention, as mentioned above, such measurement is carried out indirectly, by monitoring the force imparted by the tool T to the hand of the operator during the use of the tool T.

For such purpose, the sensors 3 of the auxiliary measurement glove 4 are located at the various phalanges of the fingers of the hand and at selected areas of the palm. The signals emitted by the sensors 3 are sent to an electronic processing unit 5 (see FIG. 4) which processes them and sends to the display means 6 the information regarding the counter-knock imparted by the tool to the wrist of the operator.

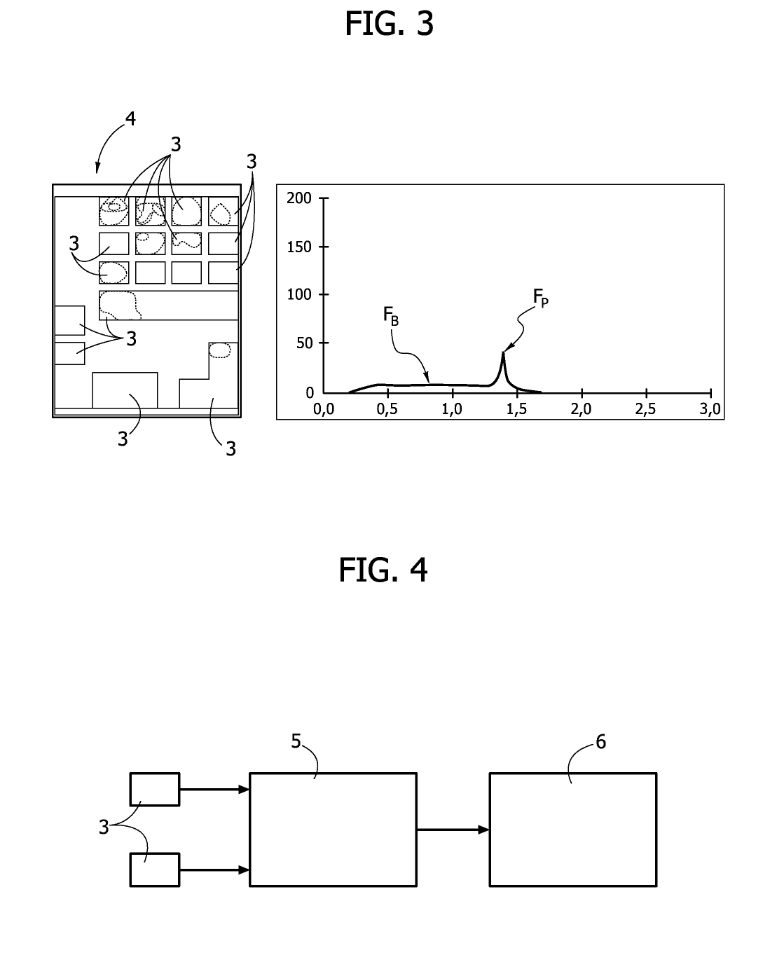

FIG. 3 shows a display example, in which at the left part there is indicated a schematic illustration of the hand and the various sensors 3 associated thereto. As observable, in the case of the invention, there are provided two sensors 3 associated to the thumbs, three sensors 3 associated to the phalanges of each of the other four fingers, two sensors 3 to the two sides and to the base of the palm of the hand, and one or more sensors 3 at the area of the palm adjacent to the fingers.

The right part of FIG. 3 is a diagram showing—in ordinates—the degree of the force expressed in Newtons and in abscissas the time in seconds. The diagram of FIG. 3 shows the variation—over time—of the force imparted by the tool T on the hand during the use of the tool. As observable in FIG. 3, the diagram comprises a substantially horizontal area, with constant force, corresponding to a value F_{B} of the force imparted by the tool T to the hand when the operator 1 simply grips the tool, before performing the operation. The diagram of FIG. 3 quickly reaches a peak value F_{P} when the operation is performed.

According to the invention, the processing unit 5 after detecting the values F_{B} and values F_{P} calculates the difference F_{P}-F_{B} and considers the value obtained as an index of the degree of the counter-knock imparted to the wrist 2 during the performance of the operation.

Studies and experiments conducted by the applicant revealed that this allows accurately and reliably monitoring the work of the operator ensuring that it is always carried out under ergonomically acceptable conditions. Thus, it is sufficient to verify whether the index thus measured is always maintained below a predefined maximum value.

Naturally, without prejudice to the principle of the invention, the construction details and the embodiments may widely vary with respect to what has been described and illustrated purely by way of example, without departing from the scope of protection of the present invention.

1. Method for designing a protective glove, to be used for imparting slight knocks in performing a cycle of manual operations in an industrial production line and for absorbing the counter-knock received when using a tool or equipment gripped by the operator during said operating cycle,
said method being characterised in that there are provided means for sensing the forces the various areas of the hand are subjected to during said operating cycle, and signals of said sensor means are processed so as to obtain a classification of the areas of the hand according to the value of the forces to which they are subjected,
and in that said glove is designed having areas that provide differentiated protections, having pads of different thickness calculated as a function of the aforementioned classification of the various areas of the hand.

2. Method according to claim 1, wherein said sensor means comprise a plurality of force sensors provided in an auxiliary glove, serving as a measurement instrument, which is used for designing the glove with differentiated protection.

3. Method according to claim 2, wherein said sensors are provided on various phalanges of each finger of the hand of the auxiliary glove and at two lateral areas at the base of the palm and at the opposite area of the palm, adjacent to the fingers.

4. Method according to claim 1, wherein said sensors are also used for measuring the counter-knock received by the wrist of the operator when using a tool gripped by the operator, said sensor means being connected to processing means programmed for monitoring, during the use of the tool, the variation of the force imparted by the tool to the hand of the operator and for particularly determining:
a base value of said force, corresponding to when the hand of the operator grips the tool before performing an operation using the tool,
a peak value achieved by said force during the use of the tool,
said processing means being programmed for calculating the difference between said peak value and said base value of said force and for sending—to display means—an indirect measurement of the counter-knock to which the wrist of the operator is subjected, according to the aforementioned difference of force values imparted to the hand.

5. Method according to claim 4, wherein said processing means are programmed for signalling upon detecting that the aforementioned value difference exceeds a predefined level.

6. Protective glove for imparting slight knocks in performing a cycle of manual operations in an industrial line and for absorbing the counter-knock received when using a tool or equipment gripped by the operator during said operating cycle, characterised in that it is designed through the method according to claim 1, and it has a plurality of areas that provide differentiated protections, having pads of different thickness, calculated as a function of the value of the forces the various areas of the hand are subjected to during the aforementioned operating cycle.

7. Glove according to claim 6, wherein said areas with differentiated protection include:
areas of maximum protection, with maximum thickness pad,
areas of intermediate protection, with intermediate thickness pad,
areas of minimum protection, with minimum thickness pad, and
areas without pad.

8. Glove according to claim 7, wherein it provides for a lining made of fabric with pads made of foamed plastic material.

9. Glove according to claim 7, wherein the thicknesses of the pads in the areas of maximum protection, in the areas of intermediate protection and in the areas of minimum protection are approximately provided at the 4.5:3:2 ratio with respect to each other.

10. Glove according to according to claim 7, wherein the areas of maximum protection are located on the inner face of the wrist and on a proximal portion of the palm adjacent to the wrist, as well as on a part of the back of the hand, on the side of the little finger; the areas with intermediate protection are located in areas of the palm at the borders of the aforementioned proximal portion of the palm, on a distal portion of the palm adjacent to the base of the index finger and middle finger, on the knuckles of the phalanges and on the back of the wrist; and the areas with minimum protection are located on a distal part of the palm adjacent to the base of the ring finger and little finger and on the tips of the thumb, index finger and middle finger, said glove being without pad at the remaining parts of the hand.
